(19) United States
(12) Patent Application Publication
(10) Pub. No.: US 2008/0195653 A1
(43) Pub. Date: Aug. 14, 2008

(54) COMMUNICATION SYSTEM AND DATA MANAGEMENT METHOD THEREOF

(76) Inventors: Yu-Lin Tsai, Taipei City (TW); Yung-Lang Huang, Taipei City (TW); Tian-Sen Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/030,212

(22) Filed: Feb. 13, 2008

(30) Foreign Application Priority Data
Feb. 13, 2007 (TW) 096105307

(51) Int. Cl. G06F 7/10; G06F 17/30

(52) U.S. Cl. 707/102; 707/E17.014

(57) ABSTRACT

The present invention discloses a data management method applied in a communication system. The data management method includes the steps of: receiving a data from a transmitting end; determining a specific user identification code corresponding to the data; and storing the data into a data group according to the specific user identification code. The step of storing the data into the data group according to the specific user identification code includes the steps of: determining if the data group allocated for the specific user identification code exists in the communication system; if the data group exists in the communication system, storing the data into the corresponding data group; and if the data group does not exist in the communication system, generating a new data group in the communication system and storing the data into the new data group.

### BACKGROUND OF THE INVENTION

1. Field of the Invention

The present invention relates to a data management mechanism in a communication system, and more particularly to a method that categorizes received data for the purpose of data storing/data searching, and a related communication system.

2. Description of the Prior Art

In the conventional communications field, when a mobile phone receives messages/notes from a transmitter, the messages and the notes are put into the same data group (e.g. a data folder), where the messages and the information are usually sorted in accordance with the time of receiving. However, as the number of messages and notes increases, searching for the required data becomes a problem for the user. Therefore, an effective way to record and categorize received data of a mobile phone has become an importance topic in the communications field.

### SUMMARY OF THE INVENTION

One of the objectives of the present invention is to provide a method that categorizes received data for the purpose of data storing/data searching, and a related communication system.

According to an embodiment of the present invention, a data management method applied in a communication system is disclosed. The data management method comprises the steps of: receiving data from a transmitting end; determining a specific user identification code corresponding to the data; and storing the data into a data group according to the specific user identification code. The step of storing the data into the data group according to the specific user identification code comprises the steps of: determining if the data group allocated for the specific user identification code exists in the communication system; if the data group exists in the communication system, storing the data into the corresponding data group; and if the data group does not exist in the communication system, generating a new data group in the communication system and storing the data into the new data group.

According to a second embodiment of the present invention, a data management method applied in a communication system is disclosed. The management method comprises the steps of: inputting a category parameter; and selecting at least a target data according to the category parameter from a plurality of data received and stored by the communication system.

According to a third embodiment of the present invention, a communication system is disclosed. The communication system comprises a storing device and a controlling device. The storing device stores data. The controlling device is coupled to the storing device for receiving a data from a transmitting end, determining a specific user identification code corresponding to the data; and storing the data into a data group according to the specific user identification code. The controlling device further determines if a specific data group allocated for the specific user identification code exists in the communication system; if the specific data group exists in the communication system, storing the data into the corresponding data group; and if the specific data group does not exist in the communication system, generating a new data group in the communication system and storing the data into the new data group.

According to a fourth embodiment of the present invention, a communication system is disclosed. The communication system comprises a storing device and a controlling device. The storing device stores a plurality of data received by the communication system. The controlling device is coupled to the storing device for receiving a category parameter inputted to the communication system, and selecting at least a target data according to the category parameter from the plurality of data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication system according to a first embodiment of the present invention.

FIG. 2 is a flowchart illustrating a data management method utilized in the first embodiment of the communication system as shown in FIG. 1.

FIG. 3 is a flowchart illustrating a data management method according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

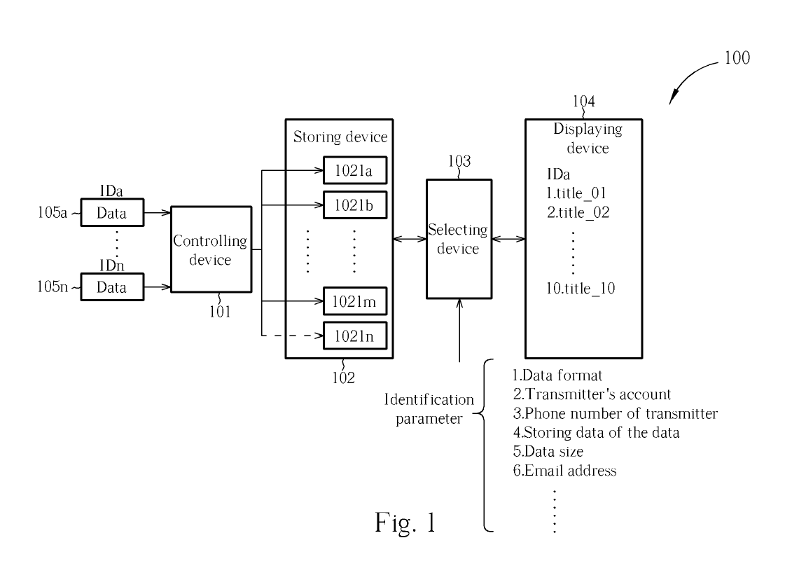

Please refer to FIG. 1. FIG. 1 is a diagram illustrating a communication system 100 according to an embodiment of the present invention. The communication system 100 comprises a controlling device 101, a storing device 102, a selecting device 103, and a displaying device 104. The controlling device 101 is utilized for categorizing the data received by the communication system 100. The storing device 102 stores the data received by the communication system 100. The selecting device 103 selects the data that has been received by the communication system 100. The displaying device 104 displays the selected result by the selecting device 103 or the content of the data selected by the selecting device 103. In order to describe the spirit of the present invention more clearly, the embodiment communication system 100 is described utilizing a Skype-phone as an example, however, this is not a limitation of the present invention. For example, any other communication system, such as a GSM mobile phone for example, also belongs to the scope of the present invention. Therefore, the communication system 100 is capable of receiving various formats of data from many different end users. The data could be a message, a note, or a multimedia content, etc. As different user ends have different respective user identification codes, in the embodiment of the present invention, the user identification code can be an account, a phone number, or an email address of the transmitter. Please note that, in order to describe the spirit of the present invention more clearly, the following paragraph only discloses the embodiment that utilizes the account of the transmitter, but this is not a limitation of the present invention. In other words, any other identification codes that are able to differentiate the transmitter belong to the scope of the present invention, e.g. phone number/email address.

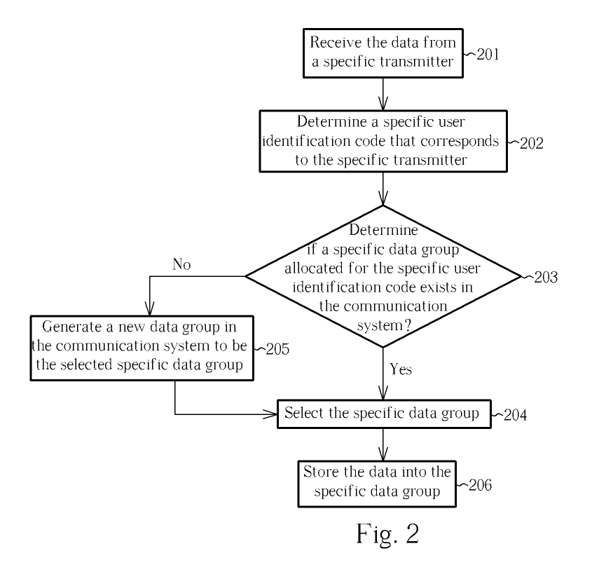

Please refer to FIG. 1 in conjunction with FIG. 2. FIG. 2 is a flowchart illustrating a data management method utilized in the first embodiment communication system 100 of the present invention. The data management method manages the stored data, and comprises the following steps:

Step 201: Receive data 105a from a specific transmitter;

Step 202: Determine a specific user identification code IDa that corresponds to the specific transmitter;

Step 203: Determine if a specific data group 1021a allocated for the specific user identification code IDa exists in the communication system 100; if the specific data group 1021a exists in the communication system 100, go to step 204; if the specific data group 1021a does not exist in the communication system 100, go to step 205;

Step 204: Select the specific data group 1021a, go to step 206;

Step 205: Generate a new data group in the communication system 100 to be the selected specific data group 1021a, go to step 204;

Step 206: Store the data 105a into the specific data group 1021a.

Please note that, in order to describe the spirit of the present invention in more clearly, the storing device 102 of the embodiment communication system 100 of the present invention comprises a plurality of predetermined data groups 1021a˜1021m, i.e. the user of the communication system 100 can build up the predetermined data groups according to known previous user ends. For example, the user of the communication system 100 can build up predetermined data groups that correspond to the user identification codes (e.g. the phone number) of the transmitters that belong to relatives and friends of the user, and store the predetermined data groups into the storing device 102. Therefore, when the data 105a of a specific transmitter is received by the communication system 100 (step 201), the controlling device 101 determines the specific user identification code IDa (step 202) that corresponds to a specific transmitter. Please refer to FIG. 1. The predetermined data group 1021a that corresponds to the specific user identification code IDa exists in the storing device 102 of the communication system 100, thus the controlling device 101 determines that the specific data group 1021a of the specific user identification code IDa exists in the communication system 100 (step 203). Then, the controlling device 101 stores the data 105a into the specific data group 1021a (step 206) automatically. Please note that each data group only comprises data that corresponds to a user identification code, however, the data management method of the present invention is not limited by the format of the data 105a. In other words, all data that corresponds to the same user identification code, which is the specific user identification code IDa, can be stored into the specific data group 1021a, such as a message, a note, or a multimedia content, etc.

Please refer to FIG. 1 and FIG. 2 again. When the data 105n of another transmitter is received by the communication system 100 (step 201), the controlling device 101 determines a user identification code IDn that corresponds to the transmitter (step 202). Meanwhile, because the storing device 102 of the communication system 100 does not yet exist in the data group that corresponds to the user identification code IDn, the controlling device 101 determines that the data group corresponding to the user identification code IDn exists in the communication system 100 (step 203). Then, the controlling device 101 generates a new data group 1021n in the storing device 102 to be the data group that corresponds to the user identification code IDn according to the user identification code IDn of the transmitter, which is determined by the controlling device 101 (step 205). When the data group 1021n is established, the controlling device 101 will then select the new data group 1021n and store the data 105n into the specific data group 1021n (step 206) automatically. Therefore, according to the embodiment communication system 100 of the present invention, if another data from the transmitter that corresponds to the user identification code IDn is received by the communication system 100 again, there is no need to generate another data group in the storing device 102 and instead the system will automatically store the received data into the data group 1021n that is built up already. Similarly, all data (even of different formats) corresponding to the user identification code IDn can be stored into the data group 1021n, such as a message, a note, or a multimedia content, etc.

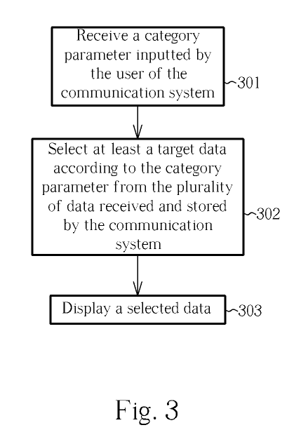

Please refer to FIG. 1 in conjunction with FIG. 3. FIG. 3 is a flowchart illustrating a data management method according to the second embodiment of the present invention. In order to describe the data management method of the present invention more clearly, the data management method is described by being applied in the communication system 100. The storing device 102 of the communication system 100 comprises a plurality of data with different data formats, such as a plurality of messages, notes, or multimedia contents. Data having different data formats will also comprise different identification parameters respectively, e.g., the transmitter's account of the data, the phone number of the transmitter, the storing date of the data, the storing time of the data, the data size, or an email address, etc. Please note that the data management method is utilized for processing data searching, and comprises the following steps:

Step 301: Receive a category parameter inputted by the user of the communication system 100;

Step 302: Select at least a target data according to the category parameter from the plurality of data received and stored by the communication system 100; and

Step 303: Display a selected data.

Please refer to FIG. 1 again. The category parameters in the embodiment can be data format, transmitter account, transmitter phone number, data storing date, data storing time, data size, or email address, etc. When the selecting device 103 of the communication 100 receives the category parameter (e.g. the transmitter account IDa) (step 301), the selecting device 103 performs a selection upon the plurality of the data stored in the storing device 102, and then selects all of the target data title_01˜title_10 corresponding to the same transmitter account IDa (step 302). Then, according to the embodiment of the present invention, the selected target data title_01˜title_10 (i.e., the searching results) are displayed on the displaying device 104 (step 303). For example, all of the data names of the target data or partial name of the contents of the target data are displayed on the displaying device 104 in order to show the target data to the user of the communication system 100.

Please note that the communication system 100 as shown in FIG. 1 supports both the data management methods as shown in FIG. 2 (i.e., the data storing) and FIG. 3 (i.e., the data searching), however, the present invention is not limited in implementing both data management methods in the same communication system. In other words, another embodiment of the present invention may only utilize with the data management method as shown in FIG. 2, whereas yet another embodiment of the present invention may only utilize the data management method as shown in FIG. 3. Furthermore, the controlling device 101 and/or the selecting device 103 of the communication system 100 as shown in FIG. 1 can be implemented in hardware, and can also be implemented by software (e.g., the driver). In addition, all design variations of the above-disclosed methods belong to the scope of the present invention.

Those skilled in the art will readily observe that numerous modifications and alterations of the device and method may be made while retaining the teachings of the invention.

What is claimed is:

1. A data management method applied in a communication system, comprising:
receiving a data from a transmitting end;
determining a specific user identification code corresponding to the data; and
storing the data into a data group according to the specific user identification code;
wherein the step of storing the data into the data group according to the specific user identification code comprises:
determining if the data group allocated for the specific user identification code exists in the communication system;
if the data group exists in the communication system, storing the data into the corresponding data group; and
if the data group does not exist in the communication system, generating a new data group in the communication system and storing the data into the new data group.

2. The data management method of claim 1, wherein each of the data group only comprises data that corresponds to a user identification code.

3. The data management method of claim 1, wherein the user identification code comprises an account, a phone number, or an email address of the transmitting end.

4. The data management method of claim 1, wherein the data comprises a message, a note, or a multimedia content.

5. The data management method of claim 1, wherein the communication system is a net-phone or a mobile phone.

6. A data management method applied in a communication system, comprising:
inputting a category parameter; and
selecting at least a target data according to the category parameter from a plurality of data received and stored by the communication system.

7. The data management method of claim 6, wherein the category parameter comprises an account of a transmitter, a phone number of the transmitter, a storing date of the data, a storing time of the data, a data size, or an email address.

8. The data management method of claim 6, wherein each of the plurality of data can be a message, a note, or a multimedia content.

9. The data management method of claim 6, wherein the communication system is a net-phone or a mobile phone.

10. A communication system, comprising:
a storing device, for storing data; and
a controlling device, coupled to the storing device, for receiving a data from a transmitting end, determining a specific user identification code corresponding to the data; and storing the data into a data group according to the specific user identification code;
wherein the controlling device further determines if a specific data group allocated for the specific user identification code exists in the communication system; if the specific data group exists in the communication system, storing the data into the corresponding data group; and if the specific data group does not exist in the communication system, generating a new data group in the communication system and storing the data into the new data group.

11. The data management method of claim 10, wherein each of the data group only comprises data that corresponds to a user identification code.

12. The data management method of claim 10, wherein the user identification code comprises an account, a phone number, or an email address of the transmitting end.

13. The data management method of claim 10, wherein the data comprises a message, a note, or a multimedia content.

14. The data management method of claim 13, wherein the communication system is a net-phone or a mobile phone.

15. A communication system, comprising:
a storing device, for storing a plurality of data received by the communication system; and
a controlling device, coupled to the storing device, for receiving a category parameter inputted to the communication system, and selecting at least a target data according to the category parameter from the plurality of data.

16. The data management method of claim 15, wherein the category parameter comprises an account of a transmitter, a phone number of the transmitter, a storing date of the data, a storing time of the data, a data size, or an email address.

17. The data management method of claim 15, wherein each data within the plurality of data comprises a message, a note, or a multimedia content.

18. The data management method of claim 15, wherein the communication system is a net-phone.

19. The data management method of claim 13, wherein the communication system is a mobile phone.
